(19) United States
(12) Patent Application Publication
(10) Pub. No.: US 2015/0319743 A1
(43) Pub. Date: Nov. 5, 2015

(54) REPEATED FAST ASSOCIATED CONTROL CHANNEL

(71) Applicant: QUALCOMM Incorporated, San Diego, CA (US)

(72) Inventors: Farrukh Rashid, Farnborough (GB); Divaydeep Sikri, Woking (GB); Mukund Agarwal, Farnborough (GB); Hassan Rafique, Farnborough (GB); Cetin Altan, Farnborough (GB)

(21) Appl. No.: 14/524,655

(22) Filed: Oct. 27, 2014

Related U.S. Application Data
(60) Provisional application No. 61/986,356, filed on Apr. 30, 2014.

(51) Int. Cl. H04W 72/04

(52) U.S. Cl. CPC H04W 72/0406

(57) ABSTRACT

Fast Associated Control Channel (FACCH) information is combined if a first block of FACCH information and a repeated block of FACCH information each fail a respective integrity check. An algorithm for realizing repeated FACCH diversity combining gains for different codec and discontinuous transmission (DTX) configurations is applicable to Full Rate codecs, Half Rate codecs, and discontinuous transmission scenarios. A pair of buffers may be used in a ping-pong fashion to store decoding soft or hard decisions for failed FACCH blocks.

### CROSS-REFERENCE TO RELATED APPLICATION(S)

This application claims priority to and the benefit of provisional patent application No. 61/986,356 filed in the U.S. patent office on Apr. 30, 2014, the entire content of which is incorporated herein by reference.

### BACKGROUND

1. Field of the Disclosure

Aspects of the present disclosure relate generally to wireless communication, and more particularly, but not exclusively, to repeated fast associated control channel (R-FACCH) functionality.

2. Description of Related Art

Wireless communication networks are widely deployed to provide various communication services such as telephony, video, data, messaging, broadcasts, and so on. Such networks, which are usually multiple access networks, support communications for multiple users by sharing the available network resources. As the demand for mobile broadband access continues to increase, research and development continue to advance the technologies not only to meet the growing demand for mobile broadband access, but to advance and enhance the user experience with mobile communications.

In poor signaling environments or conditions, decoding of a block of received information may be unsuccessful. A greater success rate in terms of decoding would tend to improve communication performance.

For example, a network can send signaling messages during a circuit switched (CS) call by “stealing” blocks from the traffic channel and sending messages in those stolen blocks on a Fast Associated Control Channel (FACCH). According to the 3rd Generation Partnership Project (3GPP) specification, the network or base station subsystem (BSS) has the choice to repeat a FACCH block in the downlink at a given frame number offset from the original FACCH block to provide time diversity. An access terminal such as a user equipment (UE) can attempt to decode received FACCH blocks, and if the original FACCH block and the repeated FACCH (R-FACCH) block each fail a cyclic redundancy check (CRC), the two blocks can be combined and decoding is attempted on the combined copy. This improves the chance of passing CRC in poor signal conditions by virtue of the diversity combining gain.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the disclosure provide for combining FACCH information. If a first block of FACCH information and a repeated block of FACCH information each fail a respective integrity check, the first and second blocks of FACCH information are combined to achieve combining gain.

The disclosure relates in some aspects to an algorithm for realizing R-FACCH diversity combining gains for different codec and discontinuous transmission (DTX) configurations. The algorithm is applicable to Full Rate (FR) codecs (e.g., FR, adaptive multi-rate (AMR) full rate, etc.), Half Rate (HR) codecs (e.g., HR, AMR half rate, etc.), and discontinuous transmission (DTX) scenarios.

The disclosure relates in some aspects to using a pair of buffers in a ping-pong fashion to store decoded soft or hard decisions for failed FACCH blocks. Each iteration of the algorithm manages one of the buffers. During a first iteration (e.g., ping), in the event an integrity check (e.g., CRC) fails on a received FACCH block for that iteration, the soft or hard decisions for that block may be stored in a first buffer. Subsequently, a second iteration (e.g., pong) is invoked whereby a second buffer is managed. For example, in the event a received block for this iteration is not FACCH information (e.g., the block is traffic data), the second buffer is simply flushed. A third iteration (e.g., back to ping) is then invoked. In the event a received block for the third iteration is R-FACCH information and an integrity check fails on that block, the soft or hard decisions for that block are combined with the soft or hard decisions stored in the first buffer. A similar result is obtained in a scenario where the first iteration manages the second buffer rather than the first buffer. In this way, received blocks can be properly handled even under FR, HR, and DTX scenarios.

In one aspect, the disclosure provides a method for communication including: receiving a first block; determining whether the first block is associated with a fast associated control channel (FACCH); conducting an integrity check on first FACCH information from the first block if the first block is associated with a FACCH; determining whether a buffer contains second FACCH information, wherein the determination is made if the integrity check fails; and combining the first FACCH information from the first block with the second FACCH information from the buffer if the buffer contains the second FACCH information.

Another aspect of the disclosure provides an apparatus for wireless communication that includes a memory device and a processing circuit coupled to the memory device. The processing circuit is configured to: receive a first block; determine whether the first block is associated with a fast associated control channel (FACCH); conduct an integrity check on first FACCH information from the first block if the first block is associated with a FACCH; determine whether a buffer contains second FACCH information, wherein the determination is made if the integrity check fails; and combine the first FACCH information from the first block with the second FACCH information from the buffer if the buffer contains the second FACCH information.

Another aspect of the disclosure provides an apparatus configured for wireless communication. The apparatus including: means for receiving a first block; means for determining whether the first block is associated with a fast associated control channel (FACCH); means for conducting an integrity check on first FACCH information from the first block if the first block is associated with a FACCH; means for determining whether a buffer contains second FACCH information, wherein the determination is made if the integrity check fails; and means for combining the first FACCH information from the first block with the second FACCH information from the buffer if the buffer contains the second FACCH information.

Another aspect of the disclosure provides a computer-readable medium storing computer-executable code, including code to: receive a first block; determine whether the first block is associated with a fast associated control channel (FACCH); conduct an integrity check on first FACCH information from the first block if the first block is associated with a FACCH; determine whether a buffer contains second FACCH information, wherein the determination is made if the integrity check fails; and combine the first FACCH information from the first block with the second FACCH information from the buffer if the buffer contains the second FACCH information.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 is a block diagram illustrating an example of a network environment in which one or more aspects of the present disclosure may find application.

FIG. 2 is a block diagram illustrating select components of a wireless communication system in which one or more aspects of the present disclosure may find application.

FIG. 3 is a block diagram illustrating FACCH combining in accordance with some aspects of the disclosure.

FIG. 4 is a block diagram illustrating a FACCH algorithm that iteratively uses different buffers in accordance with some aspects of the disclosure.

FIG. 5 is an exemplary mapping in accordance with a full rate communication configuration.

FIG. 6 is an exemplary mapping in accordance with a half rate communication configuration.

FIGS. 7-9 are flowcharts of an exemplary method for providing repeated FACCH (R-FACCH) functionality in accordance with some aspects of the disclosure.

FIG. 10 is a block diagram illustrating select components of an apparatus configured to implement R-FACCH in accordance with some aspects of the disclosure.

FIG. 11 is a flowchart illustrating an example of an R-FACCH process in accordance with some aspects of the disclosure.

FIG. 12 is a block diagram illustrating an example of a hardware implementation for an apparatus employing a processing system.

FIG. 13 is a block diagram illustrating an example of a base station in communication with a UE in a communication network.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### General Network Description

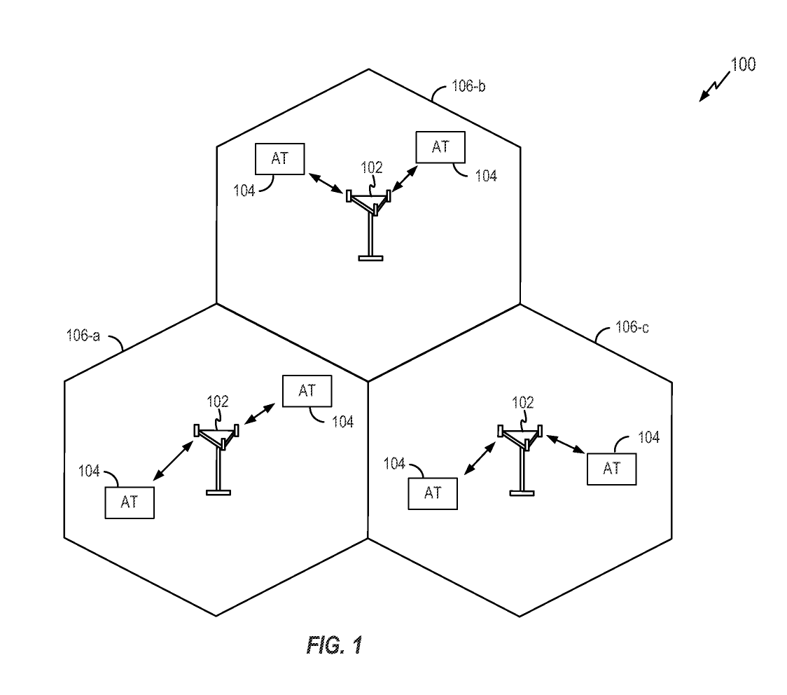

FIG. 1 is a block diagram of a network environment in which one or more aspects of the present disclosure may find application. The wireless communications system 100 includes base stations 102 adapted to communicate wirelessly with one or more access terminals (ATs) 104. The system 100 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a Single Carrier Frequency Division Multiple Access (SC-FDMA) signal, etc. Each modulated signal may be sent on a different carrier and may carry control information (e.g., pilot signals), overhead information, data, etc.

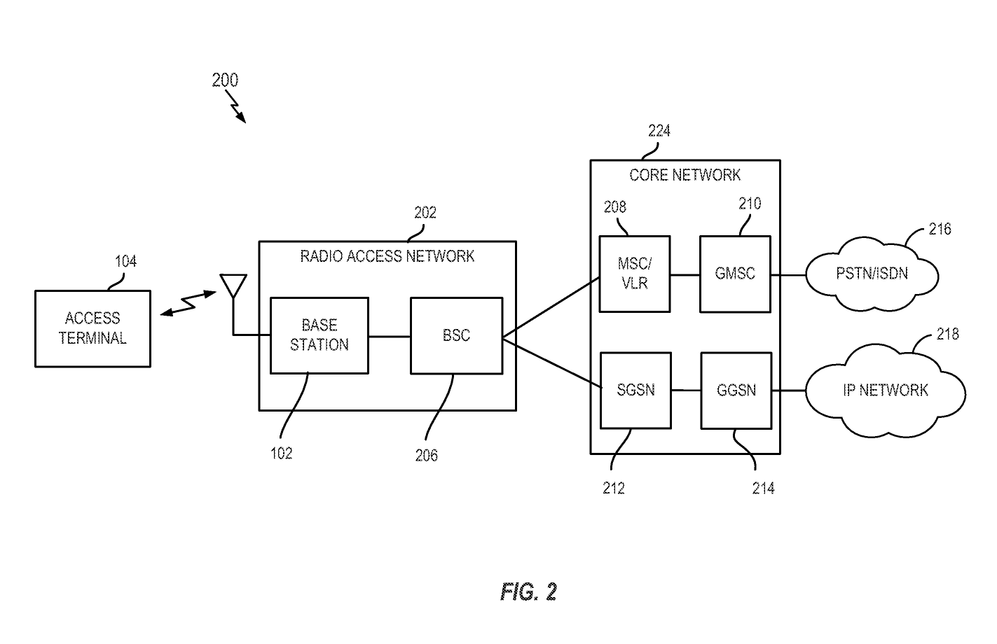

The base stations 102 can wirelessly communicate with the access terminals (e.g., UEs) 104 via a base station antenna. The base stations 102 may each be implemented generally as a device adapted to facilitate wireless connectivity (for one or more access terminals 104) to the wireless communications system 100. The base stations 102 are configured to communicate with the access terminals 104 under the control of a base station controller (see FIG. 2) via multiple carriers. Each of the base station 102 sites can provide communication coverage for a respective geographic area. The coverage area 106 for each base station 102 here is identified as cells 106-a, 106-b, or 106-c. The coverage area 106 for a base station 102 may be divided into sectors (not shown, but making up only a portion of the coverage area). The system 100 may include base stations 102 of different types (e.g., macro, micro, and/or pico base stations).

One or more access terminals 104 may be dispersed throughout the coverage areas 106. Each access terminal 104 may communicate with one or more base stations 102. An access terminal 104 may generally include one or more devices that communicate with one or more other devices through wireless signals.

Turning to FIG. 2, a block diagram 200 illustrating select components of the wireless communication system 100 is depicted according to at least one example. As illustrated, the base stations 102 are included as at least a part of a radio access network (RAN) 202. The radio access network (RAN) 202 is generally adapted to manage traffic and signaling between one or more access terminals 104 and one or more other network entities, such as network entities included in a core network 224. The radio access network 202 may, according to various implementations, be referred to by those skilled in the art as a base station subsystem (BSS), an access network, a GSM Edge Radio Access Network (GERAN), etc.

In addition to one or more base stations 102, the radio access network 202 can include a base station controller (BSC) 206, which may also be referred to by those of skill in the art as a radio network controller (RNC). The base station controller 206 is generally responsible for the establishment, release, and maintenance of wireless connections within one or more coverage areas associated with the one or more base stations 102 which are connected to the base station controller 206. The base station controller 206 can be communicatively coupled to one or more nodes or entities of the core network 224.

The core network 224 is a portion of the wireless communications system 100 that provides various services to access terminals 104 that are connected via the radio access network 202. The core network 224 may include a circuit-switched (CS) domain and a packet-switched (PS) domain. Some examples of circuit-switched entities include a mobile switching center (MSC) and visitor location register (VLR), identified as MSC/VLR 208, as well as a Gateway MSC (GMSC) 210. Some examples of packet-switched elements include a Serving GPRS Support Node (SGSN) 212 and a Gateway GPRS Support Node (GGSN) 214. Other network entities may be included, such as an EIR, HLR, VLR and AuC, some or all of which may be shared by both the circuit-switched and packet-switched domains. An access terminal 104 can obtain access to a public switched telephone network (PSTN) 216 via the circuit-switched domain, and to an IP network 218 via the packet-switched domain.

### Repeated Downlink FACCH Functionality

By way of introduction, a network (e.g., the communication system 100 of FIG. 1, or a portion thereof) may send signaling messages during a call (e.g., a circuit switched (CS) call) by stealing blocks from a traffic channel and sending messages in those blocks on a control channel (e.g., a Fast Associated Control Channel (FACCH)). As per 3GPP specifications 3GPP TS 44.006, the network/BSS has the choice or option to repeat a FACCH block in the downlink (DL) direction at given frame number offset relative to an original FACCH block to provide time diversity.

The disclosure relates in some aspects to algorithms implemented in a UE or some other entity to support the repeated FACCH feature and to provide appropriate functionality in the entity to fully utilize this time diversity in various configurations. In accordance with aspects of the disclosure, an apparatus (e.g., AT/UE 104 of FIGS. 1 and 2) may be configured to initially attempt to decode the FACCH blocks independently (e.g., separately). If original and repeated copies of a block each fail an integrity check or test (e.g., a cyclic redundancy check (CRC)) on their own, the two blocks are combined and decoding is performed on the combined copy. By combining the two blocks and decoding the combination, the likelihood of passing the integrity check increases by virtue of the diversity combining gain. Such a combination may be beneficial in environments characterized by poor signal conditions.

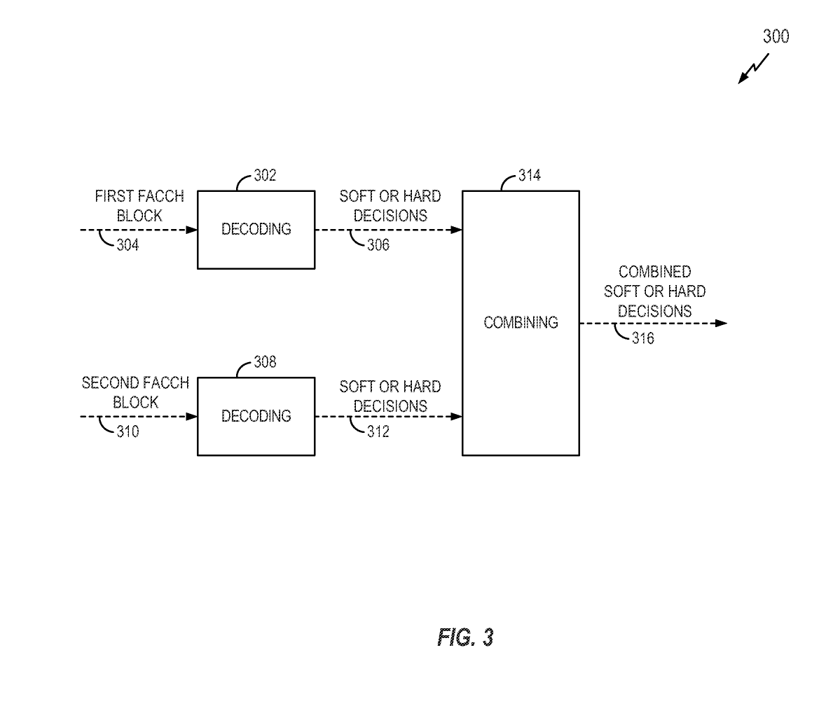

For example, as shown in the apparatus 300 of FIG. 3, decoding 302 is performed on a first FACCH block 304 to generate a first set of soft or hard decisions 306. In addition, decoding 308 is performed on a second FACCH block 310 to generate a second set of soft or hard decisions 312. If the first and second blocks each fail CRC, the soft or hard decisions 306 and 312 are combined 314 to generate combined soft or hard decisions 316.

In some implementations, the combination is weighted. For example, a block associated with higher quality (e.g., higher signal-to-noise ratio) may be weighted higher in the combination than another block associated with lower quality.

R-FACCH diversity combining gains may be realized for various configurations. Such configurations may include full rate codecs (traffic channel (TCH) full rate speech, adaptive multi-rate (AMR) full rate speech, wideband adaptive multi-rate (AMR) full rate speech etc.), half rate codecs (TCH half rate speech, AMR half rate speech, wideband AMR half rate speech etc.), or environments involving discontinuous transmission (DTX), etc.

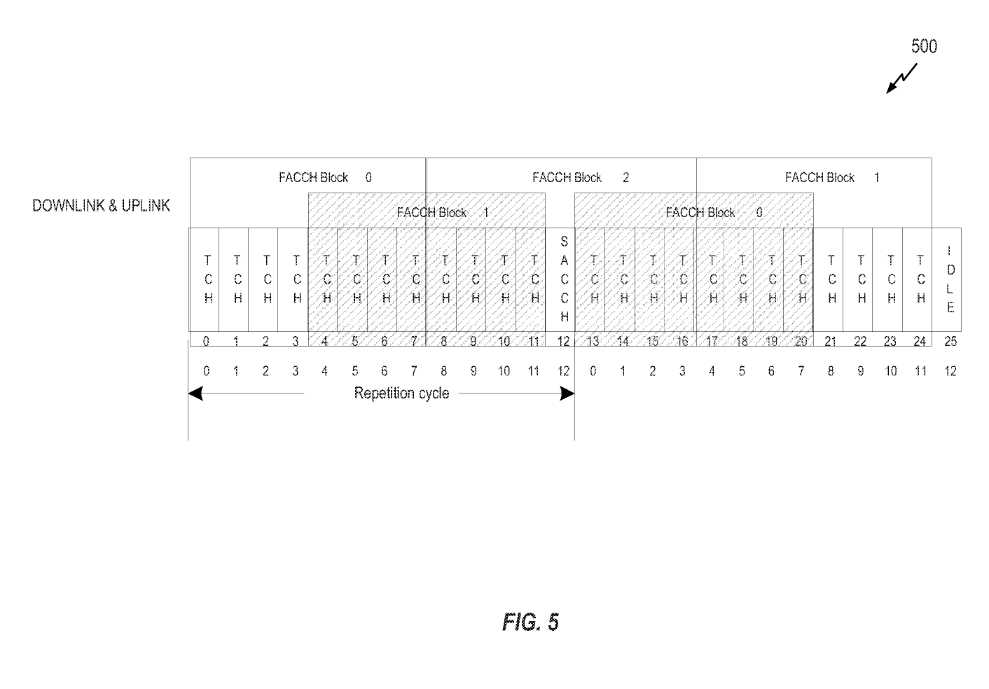

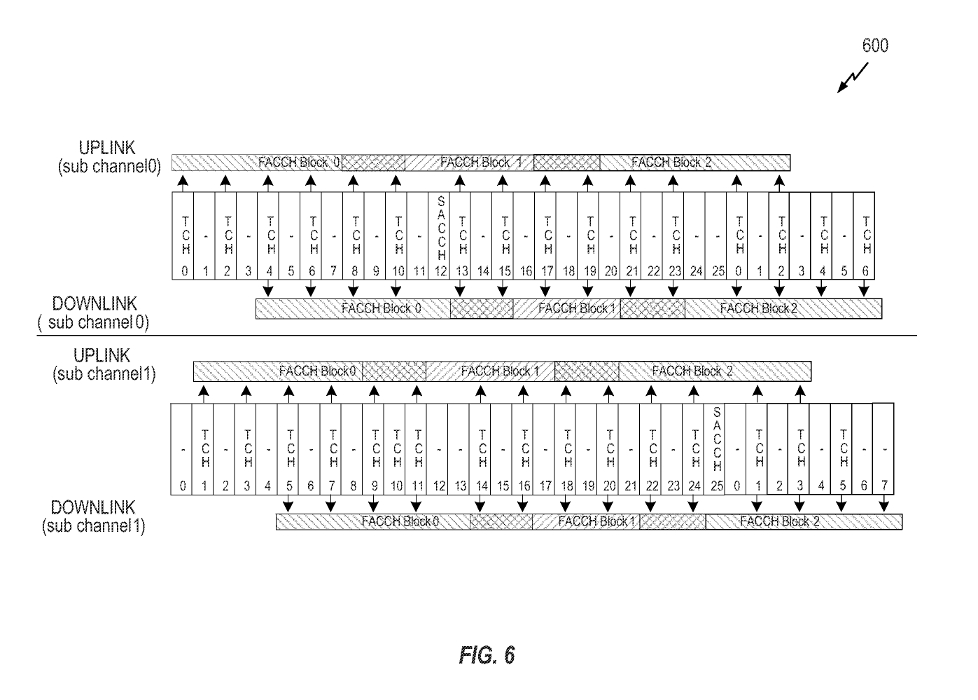

As indicated in FIGS. 5 and 6 below, a given FACCH block may occur 8 or 9 frames after the previous FACCH block (e.g., 9 frames in the case where an idle frame is present, 8 frames otherwise). However, an R-FACCH block might not immediately follow the corresponding original FACCH block. Rather, an FACCH block that carries traffic may fall between the original FACCH block and the R-FACCH block. Moreover, if DTX is employed, the transmitter (e.g., a base station) will not transmit during certain time intervals. In this case, the receiver (e.g., a UE) may improperly detect some of the silence period blocks as valid FACCH blocks.

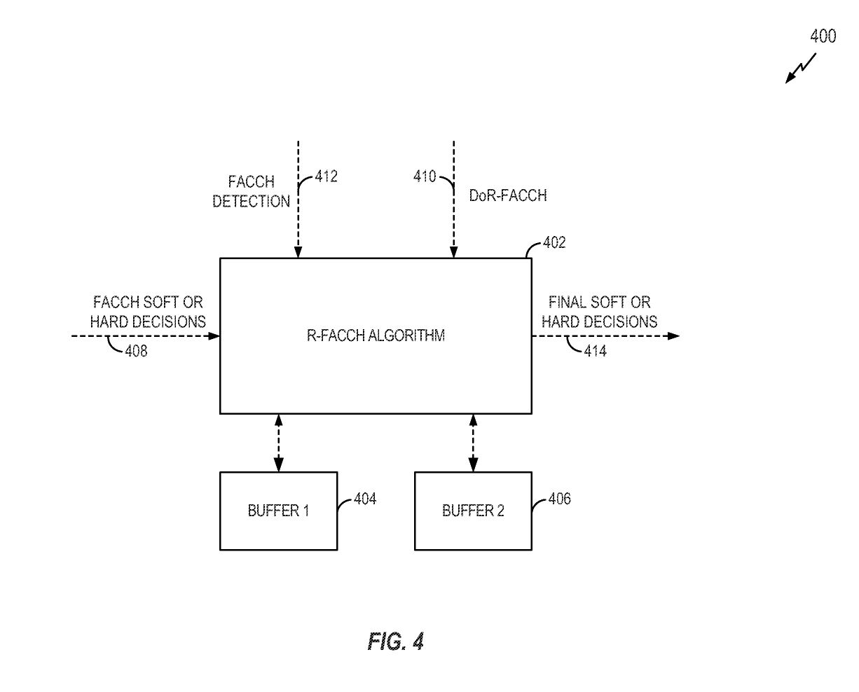

The apparatus 400 of FIG. 4 illustrates an example of an R-FACCH algorithm 402 that accommodates these scenarios and other aspects of the different configurations (FR, HR, etc.). Here, a pair of buffers 404 and 406 is used in a ping-pong fashion to store the decoding soft or hard decisions 408 for each failed FACCH block. Each iteration of the algorithm 402 manages one of the buffers. During a first iteration (e.g., ping), in the event CRC fails on a received FACCH block, the soft or hard decisions for that block are stored in the first buffer. After a number of frames corresponding to the defined frame number offset are received (e.g., as indicated by a “DoR-FACCH” flag 410), a second iteration (e.g., pong) is invoked. In the event the received block is not FACCH information (e.g., the block is traffic data) as indicated by a corresponding “FACCH detection” flag 412, the second buffer is flushed. After a number of frames corresponding to the defined frame number offset are again received, a third iteration (e.g., back to ping) is invoked. In the event the received block is FACCH information and CRC fails on that block, and if the first buffer is not empty, the soft or hard decisions for that block are combined with the soft or hard decisions stored in the first buffer. CRC is then performed on the combined final soft or hard decisions 414. A similar result is obtained in a scenario where the first iteration manages the second buffer rather than the first buffer.

In accordance with aspects of the disclosure, frame error rate performance on FACCH may show an improvement under various sensitivity/interference scenarios by utilizing the diversity combining gain, where such performance gains may be measured relative to conventional techniques.

Referring now to FIG. 5, a FACCH block mapping 500 is shown for a full rate communication configuration. Three FACCH blocks, denoted as FACCH Block 0 through FACCH Block 2, are shown. Each of the FACCH blocks is interleaved over eight (8) frames. A multi-frame length of thirteen (13) frames is provided.

Block 0 uses uplink and downlink frames 0, 1, 2, 3, 4, 5, 6, and 7. Block 1 uses uplink and downlink frames 4, 5, 6, 7, 8, 9, 10, and 11. Block 2 uses uplink and downlink frames 8, 9, 10, 11, 0/12, 1, 2, and 3.

Each of the blocks may be associated with traffic channels (TCH) and/or a slow associated control channel (SACCH). In accordance with aspects of the disclosure, only one FACCH block can be in transit in one direction (e.g., half a burst can contain FACCH data while the other half contains speech data), and a restriction may be imposed by a Layer L2 window size of one (1). It may be possible to simultaneously receive and transmit a FACCH block. The same frame mapping applies for non-VAMOS (Voice services over Adaptive Multi-user channels in One Slot) channels, VAMOS mode 1 with both TSC sets and VAMOS mode 2 with TSC set 1.

For FACCH Block 2 in FIG. 5, frame 0 applies for VAMOS mode 2 with TSC set 2, and is frame 12 otherwise.

Referring now to FIG. 6, a FACCH block mapping 600 is shown for a half rate communication configuration. Three FACCH blocks, denoted as FACCH Block 0 through FACCH Block 2, are shown. Each of the FACCH blocks is interleaved over six (6) frames. A multi-frame length of twenty six (26) frames is provided.

Block 0, sub channel 0 uses uplink frames 0, 2, 4, 6, 8, and 10. Block 0, sub channel 1 uses uplink frames 1, 3, 5, 7, 9, and 11. Block 0, sub channel 0 uses downlink frames 4, 6, 8, 10, 13/12, and 15. Block 0, sub channel 1 uses downlink frames 5, 7, 9, 11, 14, and 16.

Block 1, sub channel 0 uses uplink frames 8, 10, 13/12, 15, 17, and 19. Block 1, sub channel 1 uses uplink frames 9, 11, 14, 16, 18, and 20. Block 1, sub channel 0 uses downlink frames 13/12, 15, 17, 19, 21, and 23. Block 1, sub channel 1 uses downlink frames 14, 16, 18, 20, 22, and 24/25.

Block 2, sub channel 0 uses uplink frames 17, 19, 21, 23, 0, and 2. Block 2, sub channel 1 uses uplink frames 18, 20, 22, 24/25, 1, and 3. Block 2, sub channel 0 uses downlink frames 21, 23, 0, 2, 4, and 6. Block 2, sub channel 1 uses downlink frames 22, 24/25, 1, 3, 5, and 7.

Each of the frames may be associated with traffic channels (TCH) and/or a slow associated control channel (SACCH). In accordance with aspects of the disclosure, only one FACCH block can be in transit in one direction (e.g., half a burst can contain FACCH data while the other half contains speech data), and a restriction may be imposed by a Layer L2 window size of one (1). It may be possible to simultaneously receive and transmit a FACCH block. The same frame mapping applies for non-VAMOS channels, VAMOS mode 1 with both TSC sets and VAMOS mode 2 with TSC set 1.

Frame 12/24 applies for VAMOS mode 2 with TSC set 2, and is frame 13/25 otherwise.

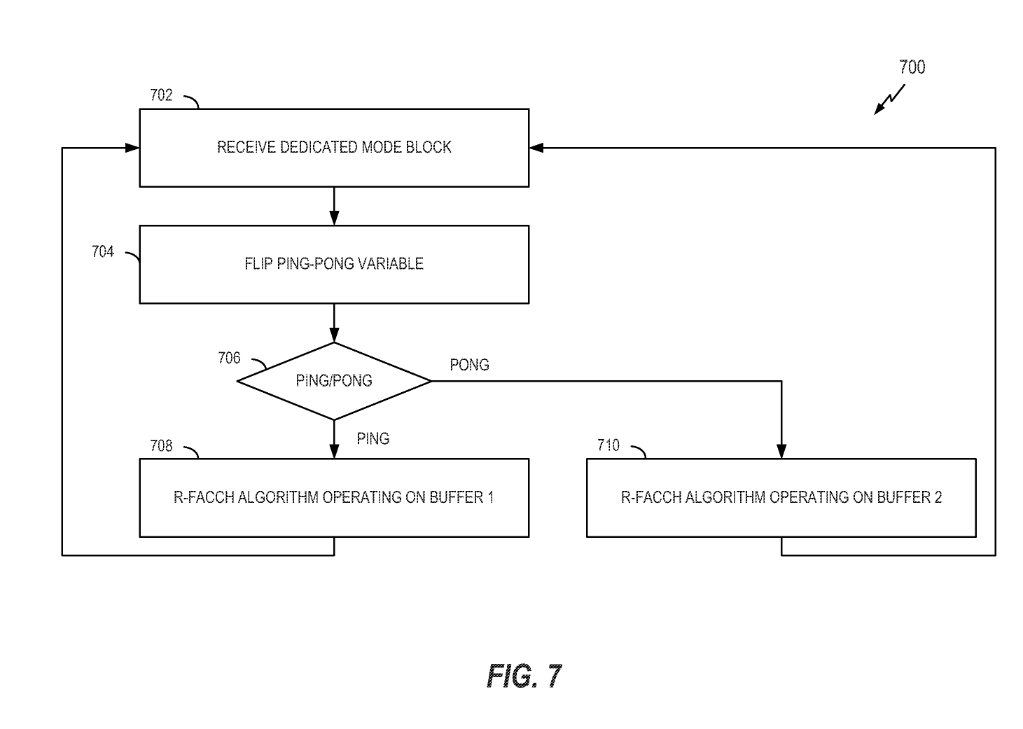

Referring now to FIG. 7, a flowchart 700 illustrating an example of an algorithm for handling R-FACCH according to aspects of the present disclosure is shown. Blocks of the flowchart 700 may be tied to (e.g., executed by) one or more systems, components or devices. For example, blocks of the flowchart 700 may be executed by one or more of the systems, components, or devices described herein.

For purposes of illustration, FIG. 7 illustrates an example that uses a binary ping-pong variable. It should be appreciated in accordance with the teachings herein that more than two states could be employed to support R-FACCH. For implementations that employ more than two states (e.g., that use three, four, or more buffers), a multi-bit variable may be used and changed (e.g., incremented) to the next state value during each iteration of the algorithm.

At block 702, a dedicated mode block is received.

At block 704, a ping pong variable, is flipped, alternated, or toggled. For example, a binary ping pong variable may be switched from 0 to 1 or from 1 to 0, depending on the previous state of the variable.

At block 706, the state or value of the ping pong variable is determined. If the variable has a first value (e.g., a value of ping), the flow proceeds to block 708 where an iteration of the R-FACCH algorithm that operates on buffer 1 is invoked. Otherwise, if the variable has a second value (e.g., a value of pong), the flow proceeds to block 710 where an iteration of the R-FACCH algorithm that operates on buffer 2 is invoked. After each iteration (either block 708 or 710), the flow proceeds back to block 702, whereby another iteration of the loop will be executed once another block is received.

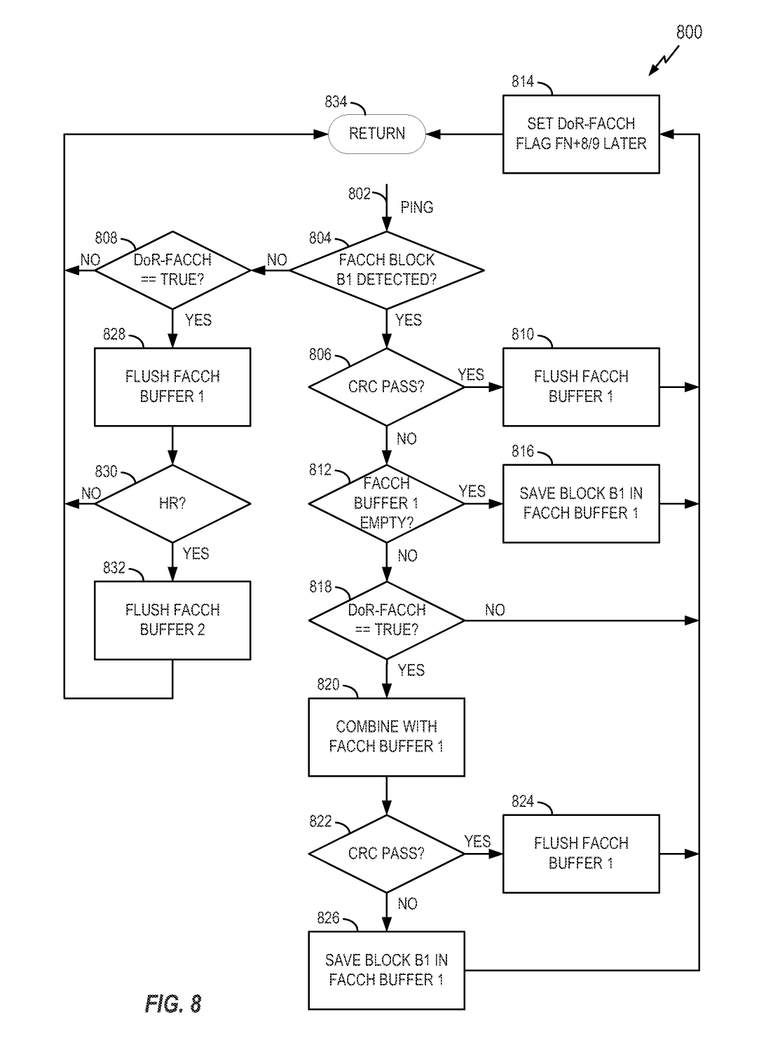

In FIG. 8, a flowchart 800 illustrates an example of the operations of block 708 of FIG. 7. These operations commence with the determination (from block 706 of FIG. 7) that the variable has a value of ping 802.

At block 804, a determination is made whether a FACCH block B1 is detected. If a FACCH block B1 is detected, the flow proceeds to block 806. Otherwise, if a FACCH block B1 is not detected, the flow proceeds to block 808. A FACCH block B1 might not be detected at block 804 if, for example, the block corresponds to a network transmission of traffic or a DTX silent period block.

At block 806, a determination is made whether a CRC integrity check (or some other suitable form of integrity check) passes or fails with respect to the FACCH block B1 of block 804. If the integrity check passes, the flow proceeds to block 810. If the integrity check does not pass or fails, the flow proceeds to block 812.

At block 810, a first FACCH buffer (FACCH buffer 1) is flushed. Flow proceeds from block 810 to block 814.

At block 812, a determination is made whether FACCH buffer 1 is empty. If FACCH buffer 1 is empty, the flow proceeds to block 816. Otherwise, if FACCH buffer 1 is not empty, the flow proceeds to block 818.

At block 816, the current FACCH block B1 is saved in FACCH buffer 1. Flow proceeds from block 810 to block 814.

At block 818, a determination is made regarding a state or value of a variable (DoR-FACCH). The DoR-FACCH variable may correspond to a binary or Boolean variable that is indicative of whether R-FACCH should be performed. If the DoR-FACCH variable has a first or ‘true’ value, the flow proceeds to block 820. Otherwise, if the DoR-FACCH variable has a second or ‘false’ value, the flow proceeds to block 814.

At block 820, a combination may be made between the current FACCH block B1 (e.g., the FACCH block B1 detected in 804) and a prior copy stored in FACCH buffer 1. Flow proceeds from block 820 to block 822.

At block 822, a determination is made whether an integrity check (e.g., a CRC check) passes or fails with respect to the combination of block 820. If the integrity check passes, the flow proceeds to block 824. If the integrity check does not pass or fails, the flow proceeds to block 826.

At block 824, FACCH buffer 1 is flushed. Flow proceeds from block 824 to block 814.

At block 826, the current FACCH block B1 is saved in FACCH buffer 1. Flow proceeds from block 826 to block 814.

At block 814, a layer (e.g., a software entity) sets the DoR-FACCH flag/variable for the decode frame that will occur at a frame number equal to the current frame (FN) plus an offset. The offset may correspond to a repeated transmission and reception of the current FACCH block. In accordance with aspects of the disclosure, the offset may have a value of eight (8) or nine (9). For example, an offset of nine may be used in instances where these two identical FACCH blocks are separated by one or more of a slow associated control channel (SACCH) frame or an idle frame. In the case of adjacent or back to back FACCH blocks, the DoR-FACCH variable is set based on both FACCH blocks. This can be accomplished through a mechanism based on the FACCH channel type of each received FACCH block or through an additional interface variable between different software entities/layers.

Referring back to block 808 mentioned above, a determination is made regarding the value of the DoR-FACCH variable. If the DoR-FACCH variable has a ‘true’ value, the flow proceeds to block 828. Otherwise, if the DoR-FACCH variable has a ‘false’ value, the flow proceeds to block 834.

At block 828, FACCH buffer 1 is flushed. Flow proceeds from block 828 to block 830.

At block 830, a determination is made regarding whether half rate (HR) communication is being used. If HR communication is being used, the flow proceeds to block 832. Otherwise, if HR communication is not being used, the flow proceeds to block 834.

At block 832, a second FACCH buffer (FACCH buffer 2) is flushed. Flow proceeds from block 832 to block 834.

Block 834 represents a return to block 702 of FIG. 7. Thus, after the operations of FIG. 8 complete, another iteration of the loop will be executed once another block is received.

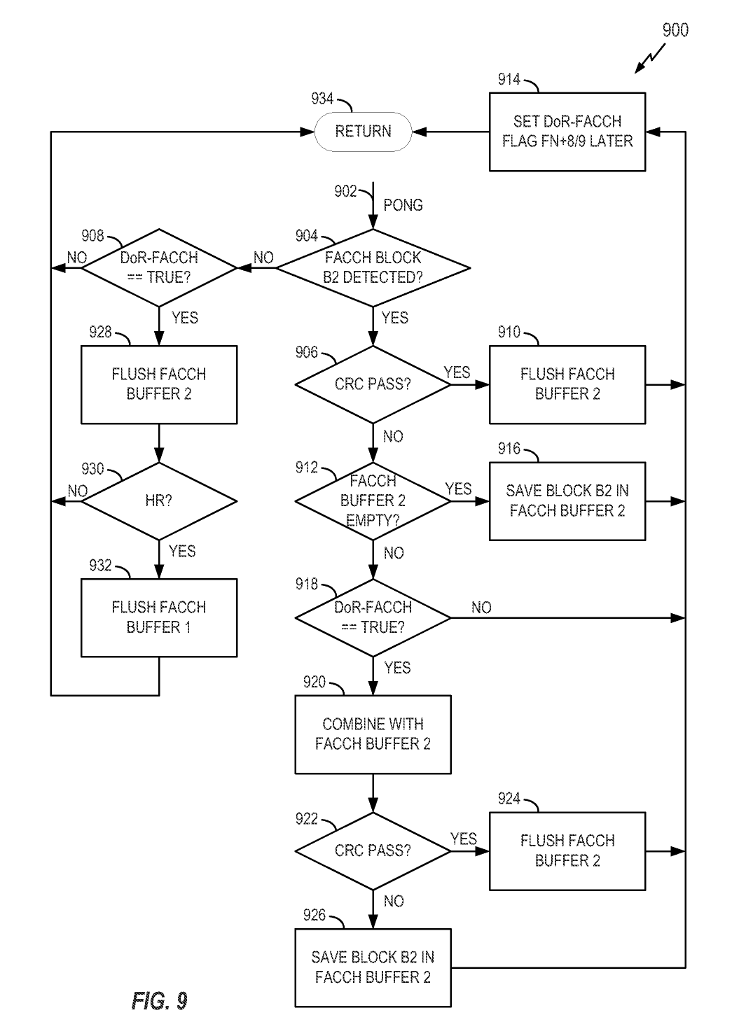

In FIG. 9, a flowchart 900 illustrates an example of the operations of the block 710 of FIG. 7. Blocks 902-934 are described below. One skilled in the art will appreciate that blocks 902-934 are analogous to blocks 802-834 described above. Differences relate to the block or buffer referenced in the blocks 902-934 relative to the blocks 802-834. The two sides, in conjunction with the toggling or flipping of the ping pong variable, may be used to accommodate the use of different FACCH blocks or block types, such as the interleaved FACCH blocks described above in connection with FIGS. 5 and 6.

The operations of FIG. 9 commence with the determination (from block 706 of FIG. 7) that the variable has a value of pong 902.

At block 904, a determination is made whether a FACCH block B2 is detected. If a FACCH block B2 is detected, the flow proceeds to block 906. Otherwise, if a FACCH block B2 is not detected, the flow proceeds to block 908. A FACCH block B2 might not be detected at block 904 if, for example, the block corresponds to a network transmission of traffic.

At block 906, a determination is made whether a CRC integrity check (or some other suitable form of integrity check) passes or fails with respect to the FACCH block B2 of block 904. If the integrity check passes, the flow proceeds to block 910. If the integrity check does not pass or fails, the flow proceeds to block 912.

At block 910, a first FACCH buffer (FACCH buffer 2) is flushed. Flow proceeds from block 910 to block 914.

At block 912, a determination is made whether FACCH buffer 2 is empty. If FACCH buffer 2 is empty, the flow proceeds to block 916. Otherwise, if FACCH buffer 2 is not empty, the flow proceeds to block 918.

At block 916, the current FACCH block B2 is saved in FACCH buffer 2. Flow proceeds from block 910 to block 914.

At block 918, a determination is made regarding a state or value of a variable (DoR-FACCH). The DoR-FACCH variable may correspond to a binary or Boolean variable that is indicative of whether R-FACCH should be performed. If the DoR-FACCH variable has a first or ‘true’ value, the flow proceeds to block 920. Otherwise, if the DoR-FACCH variable has a second or ‘false’ value, the flow proceeds to block 914.

At block 920, a combination may be made between the current FACCH block B2 (e.g., the FACCH block B2 detected in 904) and a prior copy stored in FACCH buffer 2. Flow proceeds from block 920 to block 922.

At block 922, a determination is made whether an integrity check (e.g., a CRC check) passes or fails with respect to the combination of block 920. If the integrity check passes, the flow proceeds to block 924. If the integrity check does not pass or fails, the flow proceeds to block 926.

At block 924, FACCH buffer 2 is flushed. Flow proceeds from block 924 to block 914.

At block 926, the current FACCH block B2 is saved in FACCH buffer 2. Flow proceeds from block 926 to block 914.

At block 914, a layer (e.g., a software entity) sets the DoR-FACCH flag/variable for the decode frame that will occur at a frame number equal to the current frame (FN) plus an offset. The offset may correspond to a repeated transmission and reception of the current FACCH block. In accordance with aspects of the disclosure, the offset may have a value of eight (8) or nine (9). For example, an offset of nine may be used in instances where these two identical FACCH blocks are separated by one or more of a slow associated control channel (SACCH) frame or an idle frame. In the case of adjacent or back to back FACCH blocks, the DoR-FACCH variable is set based on both FACCH blocks. This can be accomplished through a mechanism based on the FACCH channel type of each received FACCH block or through an additional interface variable between different software entities/layers.

Referring back to block 908 mentioned above, a determination is made regarding the value of the DoR-FACCH variable. If the DoR-FACCH variable has a ‘true’ value, the flow proceeds to block 928. Otherwise, if the DoR-FACCH variable has a ‘false’ value, the flow proceeds to block 934.

At block 928, FACCH buffer 2 is flushed. Flow proceeds from block 928 to block 930.

At block 930, a determination is made regarding whether half rate (HR) communication is being used. If HR communication is being used, the flow proceeds to block 932. Otherwise, if HR communication is not being used, the flow proceeds to block 934.

At block 932, a second FACCH buffer (FACCH buffer 1) is flushed. Flow proceeds from block 932 to block 934.

Block 934 represents a return to block 702 of FIG. 7. Thus, after the operations of FIG. 9 complete, another iteration of the loop will be executed once another block is received.

In accordance with aspects of the disclosure, an entity (e.g., a UE) might not support R-FACCH. A flag or indicator of whether the entity supports R-FACCH may be signaled to the network via a UE capability message. If the entity does not support R-FACCH, the DoR-FACCH flag/variable referenced in FIGS. 8 and 9 may be set to “false.”

In accordance with aspects of the disclosure, the ping pong buffers (e.g., FACCH buffer 1 and FACCH buffer 2) and the ping pong variable may be reset (e.g., reset to an initial state) upon entering a dedicated mode. The ping pong buffers and the ping pong variable may be reset during a handover (HO). The HO may be an inter-cell HO (e.g., from a first cell to a second cell) or an intra-cell HO (e.g., from a first channel to a second channel).

### Applicability to One or More Standards

Aspects of the disclosure may be applied in connection with one or more standards. By way of illustrative example, aspects of the disclosure may be applied in connection with the 3GPP Technical Specification (TS) 44.006. Portions of section 10 of the 3GPP TS 44.006 V11.0.0 (September 2012) are included below, referenced by sub-clauses 10.1-10.4 and shown in italics.

### 10.1 General

The Repeated Downlink FACCH functionality is applicable when sending LAPDm frames on the TCH/F or TCH/H channel (excluding O-TCH and E-TCH channels). An MS supporting the TCH/F or TCH/H, as described above, shall support the Repeated Downlink FACCH functionality. The BSS may use the Repeated Downlink FACCH functionality when it considers it to be appropriate.

### 10.2 The FACCH Repetition

A repeated FACCH block shall be sent in such a way that, if the first burst of the downlink FACCH block containing the first instance of a LAPDm frame is sent in TDMA frame M, the first burst of the downlink FACCH block containing the repeated instance of the LAPDm frame is sent in TDMA frame M+8 or M+9 (the latter corresponding to the case where the two FACCH blocks are separated by either a SACCH frame or an idle frame, see 3GPP TS 45.002).

NOTE: On a channel using Repeated Downlink FACCH the value of T200 should be increased to cope with the case where the receiving entity failed to decode the downlink FACCH block used to send the first instance of a repeated LAPDm frame. This applies to a BSS supporting Repeated Downlink FACCH and to an MS that has signaled the Repeated ACCH Capability bit as ‘1’ (see 3GPP TS 24.008).

### 10.3 BSS Requirements

The BSS may, based on implementation-dependent criteria (e.g. downlink measurements), decide to repeat any downlink LAPDm command frame sent in a FACCH block over the radio interface. If the MS has signaled the Repeated ACCH Capability bit as ‘1’ (see 3GPP TS 24.008), the BSS may also, based on implementation-dependent criteria, decide to repeat any downlink LAPDm response frame sent in a FACCH block over the radio interface. In both cases, the repeated FACCH block shall be sent as specified in sub-clause 10.2.

NOTE: If an MS has not signaled a Repeated ACCH Capability bit as ‘1’ the BSS may only use Repeated Downlink FACCH to send command frames.

### 10.4 MS Requirements

The MS shall, when receiving a downlink FACCH block, always attempt to decode it without combining with any previously received FACCH block. If the current FACCH block is successfully decoded and an identical FACCH block was previously received (successfully decoded and spaced in time from the current FACCH block as specified in sub-clause 10.2), the MS shall not send the LAPDm frame of the current FACCH block to the LAPDm entity. If the current FACCH block is successfully decoded and there was no such previously received identical FACCH block the LAPDm frame of the current FACCH block is sent to the LAPDm entity. If the current FACCH block is unsuccessfully decoded and there was an unsuccessfully decoded FACCH block spaced in time from the current FACCH block as specified in sub-clause 10.2, a new decoding using the information from both these FACCH blocks shall be performed. If this decoding is successful the LAPDm frame produced by the new decoding is sent to the LAPDm entity.

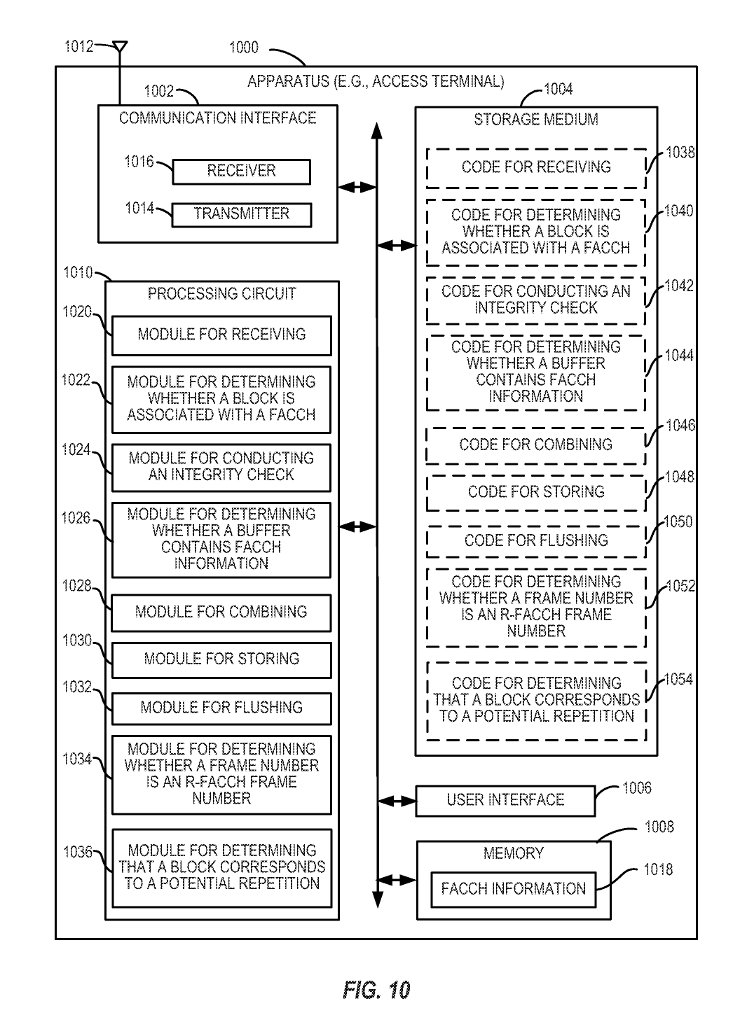

FIG. 10 is an illustration of an apparatus 1000 (e.g., including transmitting and receiving device functionality) configured according to one or more aspects of the disclosure. The apparatus 1000 includes a communication interface (e.g., at least one transceiver) 1002, a storage medium 1004, a user interface 1006, a memory 1008, and a processing circuit 1010.

These components can be coupled to and/or placed in electrical communication with one another via a signaling bus or other suitable component, represented generally by the connection lines in FIG. 10. The signaling bus may include any number of interconnecting buses and bridges depending on the specific application of the processing circuit 1010 and the overall design constraints. The signaling bus links together various circuits such that each of the communication interface 1002, the storage medium 1004, the user interface 1006, and the memory 1008 are coupled to and/or in electrical communication with the processing circuit 1010. The signaling bus may also link various other circuits (not shown) such as timing sources, peripherals, voltage regulators, and power management circuits, which are well known in the art, and therefore, will not be described any further.

The communication interface 1002 may be adapted to facilitate wireless communication of the apparatus 1000. For example, the communication interface 1002 may include circuitry and/or programming adapted to facilitate the communication of information bi-directionally with respect to one or more communication devices in a network. The communication interface 1002 may be coupled to one or more antennas 1012 for wireless communication within a wireless communication system. The communication interface 1002 can be configured with one or more standalone receivers and/or transmitters, as well as one or more transceivers. In the illustrated example, the communication interface 1002 includes a transmitter 1014 and a receiver 1016.

The memory 1008 may represent one or more memory devices. As indicated, the memory 1008 may maintain FACCH information 1018 along with other information used by the apparatus 1000. In some implementations, the memory 1008 and the storage medium 1004 are implemented as a common memory component. The memory 1008 may also be used for storing data that is manipulated by the processing circuit 1010 or some other component of the apparatus 1000.

The storage medium 1004 may represent one or more computer-readable, machine-readable, and/or processor-readable devices for storing programming, such as processor executable code or instructions (e.g., software, firmware), electronic data, databases, or other digital information. The storage medium 1004 may also be used for storing data that is manipulated by the processing circuit 1010 when executing programming. The storage medium 1004 may be any available media that can be accessed by a general purpose or special purpose processor, including portable or fixed storage devices, optical storage devices, and various other mediums capable of storing, containing or carrying programming.

By way of example and not limitation, the storage medium 1004 may include a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The storage medium 1004 may be embodied in an article of manufacture (e.g., a computer program product). By way of example, a computer program product may include a computer-readable medium in packaging materials. In view of the above, in some implementations, the storage medium 1004 may be a non-transitory (e.g., tangible) storage medium.

The storage medium 1004 may be coupled to the processing circuit 1010 such that the processing circuit 1010 can read information from, and write information to, the storage medium 1004. That is, the storage medium 1004 can be coupled to the processing circuit 1010 so that the storage medium 1004 is at least accessible by the processing circuit 1010, including examples where at least one storage medium is integral to the processing circuit 1010 and/or examples where at least one storage medium is separate from the processing circuit 1010 (e.g., resident in the apparatus 1000, external to the apparatus 1000, distributed across multiple entities, etc.).

Programming stored by the storage medium 1004, when executed by the processing circuit 1010, causes the processing circuit 1010 to perform one or more of the various functions and/or process operations described herein. For example, the storage medium 1004 may include operations configured for regulating operations at one or more hardware blocks of the processing circuit 1010, as well as to utilize the communication interface 1002 for wireless communication utilizing their respective communication protocols.

The processing circuit 1010 is generally adapted for processing, including the execution of such programming stored on the storage medium 1004. As used herein, the term “programming” or the term “code” shall be construed broadly to include without limitation instructions, instruction sets, data, code, code segments, program code, programs, subprograms, software modules, applications, software applications, software packages, routines, subroutines, objects, executables, threads of execution, procedures, functions, programming, etc., whether referred to as software, firmware, middleware, microcode, hardware description language, or otherwise.

The processing circuit 1010 is arranged to obtain, process and/or send data, control data access and storage, issue commands, and control other desired operations. The processing circuit 1010 may include circuitry configured to implement desired programming provided by appropriate media in at least one example. For example, the processing circuit 1010 may be implemented as one or more processors, one or more controllers, and/or other structure configured to execute executable programming. Examples of the processing circuit 1010 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1010 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1010 are for illustration and other suitable configurations within the scope of the disclosure are also contemplated.

According to one or more aspects of the disclosure, the processing circuit 1010 may be adapted to perform any or all of the features, processes, functions, operations and/or routines for any or all of the apparatuses described herein. As used herein, the term “adapted” in relation to the processing circuit 1010 may refer to the processing circuit 1010 being one or more of configured, employed, implemented, and/or programmed to perform a particular process, function, operation and/or routine according to various features described herein.

According to at least one example of the apparatus 1000, the processing circuit 1010 may include one or more of a module for receiving 1020, a module for determining whether a block is associated with a FACCH 1022, a module for conducting an integrity check 1024, a module for determining whether a buffer contains FACCH information 1026, a module for combining 1028, a module for storing 1030, a module for flushing 1032, a module for determining whether a frame number is an R-FACCH frame number 1034, and a module for determining that a block corresponds to a potential repetition 1036.

The module for receiving 1020 may include circuitry and/or programming (e.g., code for receiving 1038 stored on the storage medium 1004) adapted to perform several functions relating to, for example, receiving blocks of information (e.g., via CS frames). The module for receiving 1020 obtains received data by, for example, obtaining this data from a component of the apparatus 1000 (e.g., from the receiver 1016 or some other component). In some implementations, the module for receiving 1020 processes (e.g., decodes) the received data. The module for receiving 1020 then outputs the received data (e.g., stores the data in the memory 1008 or sends the data to another component of the apparatus 1000).

The module for determining whether a block is associated with a FACCH 1022 may include circuitry and/or programming (e.g., code for determining whether a block is associated with a FACCH 1040 stored on the storage medium 1004) adapted to perform several functions relating to, for example, determining whether a flag corresponding to FACCH is set (e.g., in a frame). In some implementations, the module for determining whether a block is associated with a FACCH 1022 obtains information representative of whether the block is associated with a FACCH. In some implementations, this involves reading an indication (e.g., a flag) from the memory 1008. Such an indication may be set, for example, by a process that keeps track of received frame numbers and thereby identifies FACCH frames. In some implementations, the module for determining whether a block is associated with a FACCH 1022 performs the determination based on information from the block. The information (e.g., the information from the block or the indication) may be compared to a specified value to determine whether the block is associated with a FACCH. An indication of whether the block is associated with a FACCH is then output (e.g., stored in the memory device 1008 or passed to another component of the apparatus 1000).

The module for conducting an integrity check 1024 may include circuitry and/or programming (e.g., code for conducting an integrity check 1042 stored on the storage medium 1004) adapted to perform several functions relating to, for example, performing an integrity check (e.g., a CRC) on information (e.g., a received block). The module for conducting an integrity check 1024 obtains information to be operated on (e.g., from at least one other component of the apparatus 1000). The module for conducting an integrity check 1024 conducts an integrity check on this information according to a designated integrity check algorithm (e.g., a CRC algorithm, a parity check algorithm, and so on). The module for conducting an integrity check 1024 then outputs an indication of whether the information passes or fails the integrity check (e.g., stores the indication in the memory 1008 or sends the data to another component of the apparatus 1000).

The module for determining whether a buffer contains FACCH information 1026 may include circuitry and/or programming (e.g., code for determining whether a buffer contains FACCH information 1044 stored on the storage medium 1004) adapted to perform several functions relating to, for example, determining whether a buffer is empty or not empty. In some implementations, the module for determining whether a buffer contains FACCH information 1026 obtains information representative of whether the buffer contains FACCH information. In some implementations, this involves reading an indication (e.g., a flag) from the memory 1008. Such an indication may be set, for example, by a process that keeps track of received frame numbers and thereby identifies FACCH frames. In some implementations, the module for determining whether a buffer contains FACCH information 1026 performs the determination based on the information stored in the buffer. The information (e.g., the information from the buffer or the indication) may be compared to a specified value to determine whether the buffer contains FACCH information. An indication of whether the buffer contains FACCH information is then output (e.g., stored in the memory device 1008 or passed to another component of the apparatus 1000).

The module for combining 1028 may include circuitry and/or programming (e.g., code for combining 1046 stored on the storage medium 1004) adapted to perform several functions relating to, for example, combining first FACCH information (e.g., soft or hard decisions) with second FACCH information (e.g., soft or hard decisions). The module for combining 1028 obtains information to be combined (e.g., from at least one other component of the apparatus 1000). The module for combining 1028 combines this information according to a designated combination algorithm (e.g., an algorithm for combining soft decisions or an algorithm for combining hard decisions). The module for combining 1028 then outputs the combined information (e.g., stores the information in the memory 1008 or sends the data to another component of the apparatus 1000).

The module for storing 1030 may include circuitry and/or programming (e.g., code for storing 1048 stored on the storage medium 1004) adapted to perform several functions relating to, for example, storing information (e.g., soft or hard decisions) in a buffer. The module for storing 1030 obtains information to be stored (e.g., from at least one other component of the apparatus 1000) and then stores the information (e.g., in the memory 1008 or some other storage device).

The module for flushing 1032 may include circuitry and/or programming (e.g., code for flushing 1032 stored on the storage medium 1004) adapted to perform several functions relating to, for example, flushing information (e.g., soft or hard decisions) from a buffer. For example, a location in memory may be cleared. The module for flushing 1032 identifies the location of information to be flushed (e.g., identifies a memory address). The module for flushing 1032 then causes the information at that location to be cleared (e.g., set to a value of 0 or some other specified value) or otherwise indicated as being cleared (e.g., by setting an indication that the information at that location should be deemed as having been “flushed”).

The module for determining whether a frame number is an R-FACCH frame number 1034 may include circuitry and/or programming (e.g., code for determining whether a frame number is an R-FACCH frame number 1052 stored on the storage medium 1004) adapted to perform several functions relating to, for example, comparing a frame number with another frame number and an offset. In some implementations, the module for determining whether a frame number is an R-FACCH frame number 1034 obtains the frame number (e.g., from the receiver 1016 or some other component). The frame number is then compared to one or more specified frame numbers (e.g., a frame number plus an offset) to determine whether the frame number is an R-FACCH frame number. An indication of whether the frame number is an R-FACCH frame number is then output (e.g., stored in the memory device 1008 or passed to another component of the apparatus 1000).

The module for determining that a block corresponds to a potential repetition 1036 may include circuitry and/or programming (e.g., code for determining that a block corresponds to a potential repetition 1054 stored on the storage medium 1004) adapted to perform several functions relating to, for example, determining whether an indication (e.g., a flag) indicative of whether a frame is a potential R-FACCH is set. In some implementations, the module for determining that a block corresponds to a potential repetition 1036 obtains the indication (e.g., from the memory 1008 or from the block). The indication is then compared to a specified value to determine whether the block corresponds to a potential repetition (e.g., the block is an R-FACCH block). An indication of whether the block corresponds to a potential repetition is then output (e.g., stored in the memory device 1008 or passed to another component of the apparatus 1000).

As mentioned above, programming stored by the storage medium 1004, when executed by the processing circuit 1010, causes the processing circuit 1010 to perform one or more of the various functions and/or process operations described herein. For example, the storage medium 1004 may include one or more of the code for receiving 1038, code for determining whether a block is associated with a FACCH 1040, code for conducting an integrity check 1042, code for determining whether a buffer contains FACCH information 1044, code for combining 1046, code for storing 1048, code for flushing 1050, code for determining whether a frame number is an R-FACCH frame number 1052, or code for determining that a block corresponds to a potential repetition 1054.

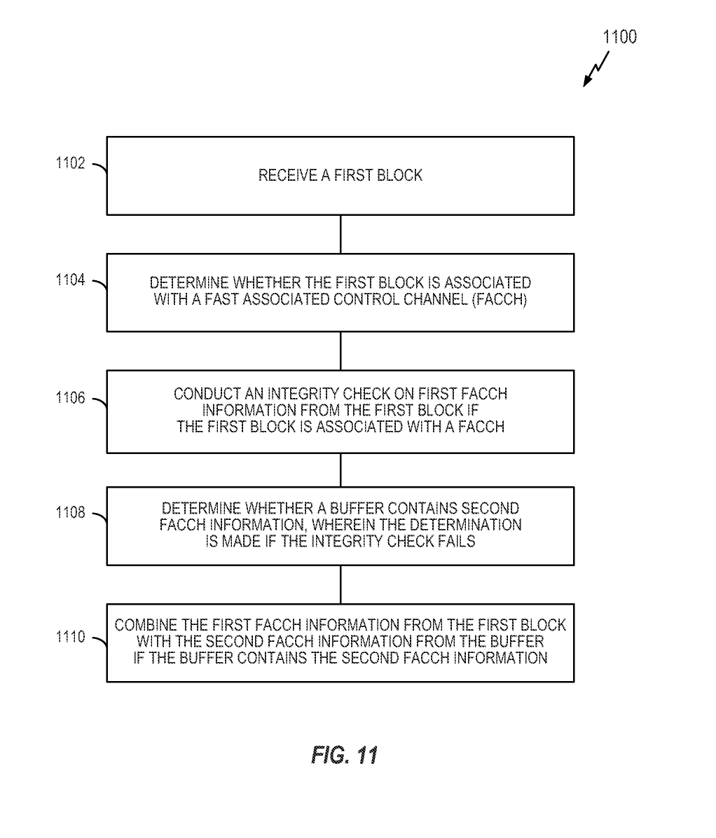

FIG. 11 illustrates a process 1100 for supporting R-FACCH in accordance with some aspects of the disclosure. The process 1100 may take place within the processing circuit 1010 (FIG. 10), which may be located at an AP, a UE, or some other suitable apparatus. In another aspect, the process 1100 may be implemented by any of the ATs 104 or any of the APs 102 illustrated in FIG. 1. Of course, in various aspects within the scope of the present disclosure, the process 1100 may be implemented by any suitable apparatus capable of supporting FACCH.

At block 1102, a first block is received. For example, a UE may receive a block (e.g., frame) while operating in dedicated mode. The corresponding signaling may employ Full Rate, Half Rate, DTX, or other types of signaling.

At block 1104, a determination is made as to whether the first block is associated with a FACCH. For example, a flag sent with the block (e.g., in a frame) may indicate whether the block is a FACCH block.

In some aspects, the determination of whether the first block is associated with a FACCH comprises determining whether a variable indicates that a frame number associated with the first block is a potential repeated FACCH (R-FACCH) frame number. In some aspects, the frame number associated with the first block is a potential repeated FACCH (R-FACCH) frame number if the frame number associated with the first block is separated from a frame number of a prior FACCH frame by a defined offset. In some aspects, the offset is eight frames or nine frames. In some aspects, the offset is nine frames if the frame number associated with the first block and the frame number of the prior FACCH frame are separated by either a slow associated control channel (SACCH) frame or an idle frame.

If the first block is not associated with a FACCH, a buffer may be flushed (e.g., cleared) if the first block corresponds to a potential R-FACCH frame. This latter determination may be made, for example, by determining whether a frame number associated with the first block is a potential repeated FACCH (R-FACCH) frame number.

As discussed herein, the buffer being cleared here is the one that corresponds to the current iteration of a cyclic pattern (e.g., a ping-pong pattern). Thus, for a ping iteration, the first buffer may be cleared.

In addition, if the first block is associated with (e.g., received via) Half Rate communication, another buffer used for storing received FACCH information may be cleared. Continuing with the ping example, the second buffer also may be cleared in this case.

At block 1106, an integrity check is conducted on first FACCH information from the first block if the first block is associated with a FACCH. For example, CRC may be applied to the soft or hard decisions that result from the decoding of the first block. In some aspects, the first FACCH information may include soft or hard decision information for (e.g., derived from) the first block.

At block 1108, a determination is made as to whether a buffer contains second FACCH information. In some aspects, the second FACCH information may include soft or hard decision information for (e.g., derived from) a second block that was received prior to the first block.

This determination is made if the integrity check fails at block 1106. For example, if the FACCH soft or hard decisions fail CRC, the UE may check to see whether the buffer is empty (e.g., the UE checks to see whether the buffer includes soft or hard decisions from a prior FACCH block). If the buffer does contain FACCH information, this indicates that the first block corresponds to an R-FACCH.

In the event the determination of whether the buffer contains second FACCH information indicates that the buffer is empty, the first FACCH information may be stored in the buffer for potential use in a subsequent R-FACCH operation.

As discussed herein, received FACCH information may be stored in different buffers according to a cyclic pattern such that, for each of the cycles of the cyclic pattern, a corresponding one of the different buffers is used to store corresponding received FACCH information. Thus, for each of the cycles of the cyclic pattern, the FACCH information from the corresponding buffer is combined with the first FACCH information. In some implementations, the different buffers consist of two buffers, whereby the cyclic pattern comprises a ping-pong pattern.

In some aspects, in a subsequent iteration (e.g., ping again), a second block is received. A determination could then be made that the second block corresponds to a potential repetition of the first block. In this case, a second integrity check is conducted on the second block. If the second integrity check passes, the buffer is flushed since a future combination with this FACCH information is not needed.

At block 1110, the first FACCH information from the first block is combined with the second FACCH information from the buffer if the buffer contains the second FACCH information. For example, if the soft or hard decisions for each of the first FACCH and the R-FACCH fail CRC, these soft or hard decisions are combined in an attempt to achieve a combination gain.

In some aspects, a second integrity check may be conducted on the combination of the first FACCH information with the second FACCH information. If the combination passes the second integrity check, the first buffer may be flushed since a future combination with this FACCH information is not needed. If the combination fails the second integrity check, the first FACCH information may be stored in the buffer for potential use in a subsequent R-FACCH operation.

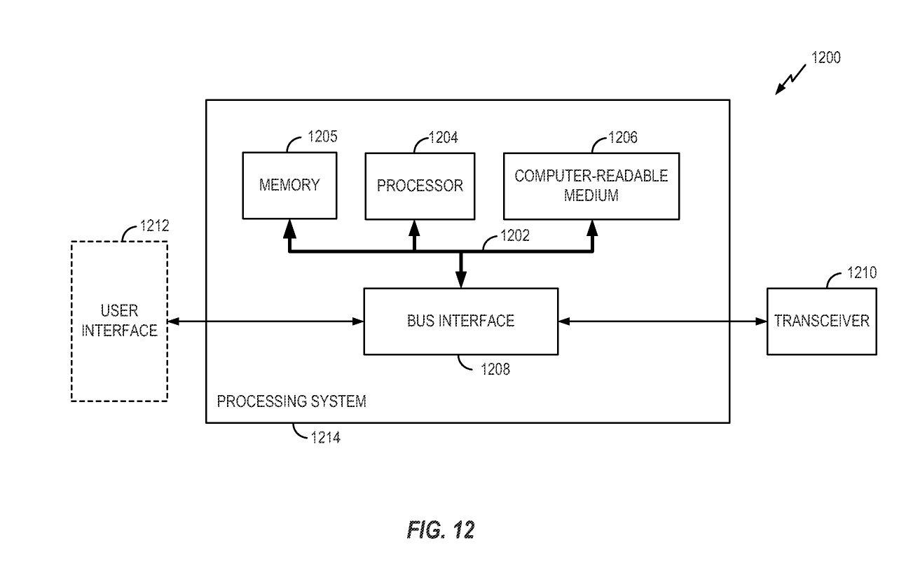

FIG. 12 is a conceptual diagram illustrating an example of a hardware implementation for an apparatus 1200 employing a processing system (e.g., a processing circuit) 1214. In accordance with various aspects of the disclosure, an element, or any portion of an element, or any combination of elements disclosed herein may be implemented with a processing system 1214 that includes one or more processors 1204. For example and without limitation, the apparatus 1200 may be an access terminal (e.g., a UE) as illustrated in any one or more of FIG. 1, 2, or 13. The processor 1204, as utilized in an apparatus 1200, may be used to implement any one or more of the processes described herein and illustrated, for example, in FIG. 3, 4, 7-9, or 11.

In this example, the processing system 1214 may be implemented with a bus architecture, represented generally by the bus 1202. The bus 1202 may include any number of interconnecting buses and bridges depending on the specific application of the processing system 1214 and the overall design constraints. The bus 1202 links together various circuits including one or more processors (represented generally by the processor 1204), a memory 1205, and computer-readable media (represented generally by the computer-readable medium 1206). The bus 1202 may also link various other circuits such as timing sources, peripherals, voltage regulators, and power management circuits, which are well known in the art, and therefore, will not be described any further. A bus interface 1208 provides an interface between the bus 1202 and a transceiver 1210. The transceiver 1210 provides a means for communicating with various other apparatus over a transmission medium. Depending upon the nature of the apparatus, a user interface 1212 (e.g., keypad, display, speaker, microphone, joystick) may also be provided.

The processor 1204 is responsible for managing the bus 1202 and general processing, including the execution of software stored on the computer-readable medium 1206. The software, when executed by the processor 1204, causes the processing system 1214 to perform the various functions described below for any particular apparatus. The computer-readable medium 1206 may also be used for storing data that is manipulated by the processor 1204 when executing software.

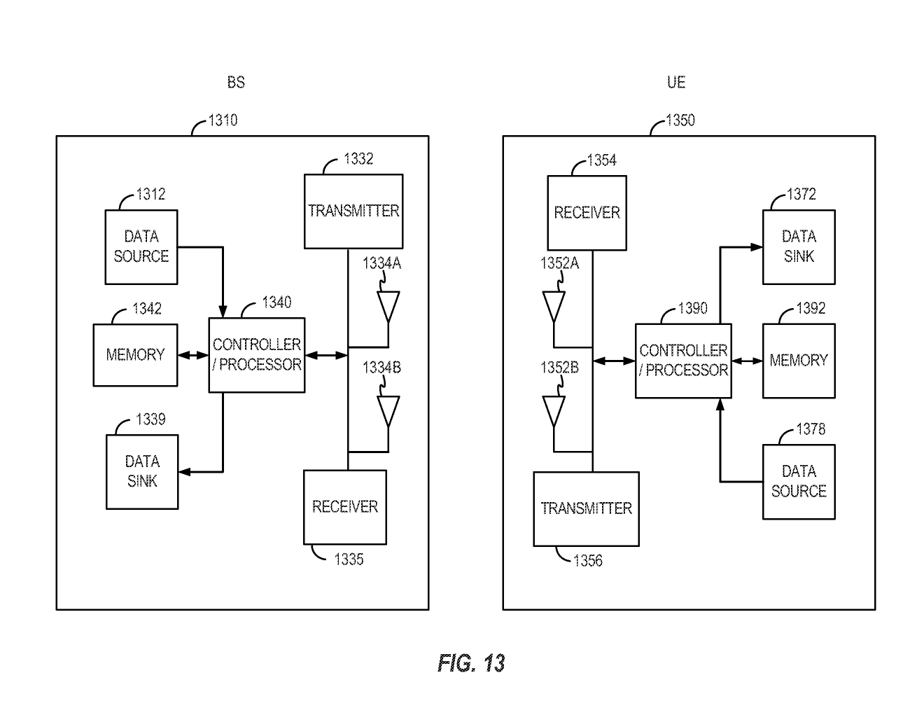

FIG. 13 is a block diagram of an exemplary base station (BS) 1310 in communication with an exemplary UE 1350, where the BS 1310 may be the BS 102 in FIG. 2, and the UE 1350 may be the AT 104 in FIG. 2. In the downlink communication, a controller or processor 1340 may receive data from a data source 1312. Channel estimates may be used by a controller/processor 1340 to determine the coding, modulation, spreading, and/or scrambling schemes for the transmit processor 1320. These channel estimates may be derived from a reference signal transmitted by the UE 1350 or from feedback from the UE 1350. A transmitter 1332 may provide various signal conditioning functions including amplifying, filtering, and modulating frames onto a carrier for downlink transmission over a wireless medium through one or more antennas 1334. The antennas 1334 may include one or more antennas, for example, including beam steering bidirectional adaptive antenna arrays, MIMO arrays, or any other suitable transmission/reception technologies.

At the UE 1350, a receiver 1354 receives the downlink transmission through one or more antennas 1352 and processes the transmission to recover the information modulated onto the carrier. The information recovered by the receiver 1354 is provided to a controller/processor 1390. The processor 1390 descrambles and despreads the symbols, and determines the most likely signal constellation points transmitted by the BS 1310 based on the modulation scheme. These soft or hard decisions may be based on channel estimates computed by the processor 1390. The soft or hard decisions are then decoded and deinterleaved to recover the data, control, and reference signals. The CRC codes are then checked to determine whether the frames were successfully decoded. The data carried by the successfully decoded frames will then be provided to a data sink 1372, which represents applications running in the UE 1350 and/or various user interfaces (e.g., display). Control signals carried by successfully decoded frames will be provided to a controller/processor 1390. When frames are unsuccessfully decoded, the controller/processor 1390 may also use an acknowledgement (ACK) and/or negative acknowledgement (NACK) protocol to support retransmission requests for those frames.

In the uplink, data from a data source 1378 and control signals from the controller/processor 1390 are provided. The data source 1378 may represent applications running in the UE 1350 and various user interfaces (e.g., keyboard). Similar to the functionality described in connection with the downlink transmission by the BS 1310, the processor 1390 provides various signal processing functions including CRC codes, coding and interleaving to facilitate FEC, mapping to signal constellations, spreading with OVSFs, and scrambling to produce a series of symbols. Channel estimates, derived by the processor 1390 from a reference signal transmitted by the BS 1310 or from feedback contained in a midamble transmitted by the BS 1310, may be used to select the appropriate coding, modulation, spreading, and/or scrambling schemes. The symbols produced by the processor 1390 will be utilized to create a frame structure. The processor 1390 creates this frame structure by multiplexing the symbols with additional information, resulting in a series of frames. The frames are then provided to a transmitter 1356, which provides various signal conditioning functions including amplification, filtering, and modulating the frames onto a carrier for uplink transmission over the wireless medium through the one or more antennas 1352.

The uplink transmission is processed at the BS 1310 in a manner similar to that described in connection with the receiver function at the UE 1350. A receiver 1335 receives the uplink transmission through the one or more antennas 1334 and processes the transmission to recover the information modulated onto the carrier. The information recovered by the receiver 1335 is provided to the processor 1340, which parses each frame. The processor 1340 performs the inverse of the processing performed by the processor 1390 in the UE 1350. The data and control signals carried by the successfully decoded frames may then be provided to a data sink 1339. If some of the frames were unsuccessfully decoded by the receive processor, the controller/processor 1340 may also use an acknowledgement (ACK) and/or negative acknowledgement (NACK) protocol to support retransmission requests for those frames.

The controller/processors 1340 and 1390 may be used to direct the operation at the BS 1310 and the UE 1350, respectively. For example, the controller/processors 1340 and 1390 may provide various functions including timing, peripheral interfaces, voltage regulation, power management, and other control functions. The computer readable media of memories 1342 and 1392 may store data and software for the BS 1310 and the UE 1350, respectively.

### CONCLUSION

Several aspects of a communication system have been presented. As those skilled in the art will readily appreciate, various aspects described throughout this disclosure may be extended to various types of communication systems, network architectures, and communication standards.

By way of example, various aspects may be extended to systems other than those implementing GSM standards, such as UMTS, utilizing any suitable air interface (e.g., W-CDMA, TD-CDMA, or TD-SCDMA). Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. Various aspects may also be extended to systems employing third generation (3G) technology, fourth generation (4G) technology, fifth generation (5G) technology, or other types of technology. The actual telecommunication standard, network architecture, and/or communication standard employed will depend on the specific application and the overall design constraints imposed on the system.

While the above discussed aspects, arrangements, and implementations are discussed with specific details and particularity, one or more of the components, operations, features and/or functions illustrated in one or more of FIG. 1-4, 10, 12, or 13 may be rearranged and/or combined into a single component, operation, feature or function or embodied in several components, operations, or functions. Additional elements, components, operations, and/or functions may also be added or not utilized without departing from the teachings herein. The apparatus, devices and/or components illustrated in one or more of FIG. 1-4, 10, 12, or 13 may be configured to perform or employ one or more of the methods, features, parameters, or operations described in one or more of FIG. 7-9, or 11.

Thus, while features of the disclosure may have been discussed relative to certain implementations and figures, all implementations of the disclosure can include one or more of the advantageous features discussed herein. In other words, while one or more implementations may have been discussed as having certain advantageous features, one or more of such features may also be used in accordance with any of the various implementations discussed herein. In similar fashion, while some implementations may have been discussed herein as device, system, or method implementations, it should be understood that such exemplary implementations can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein. Additional elements, components, steps, and/or functions may also be added or not utilized without departing from the disclosure.

Those of skill in the art would further appreciate that the various illustrative logical blocks, modules, circuits, and algorithm operations described in connection with the aspects disclosed herein may be implemented as hardware, software, firmware, middleware, microcode, or any combination thereof. To clearly illustrate this interchangeability, various illustrative components, blocks, modules, circuits, and operations have been described above generally in terms of their functionality. Whether such functionality is implemented as hardware or software depends upon the particular application and design constraints imposed on the overall system.

The teachings herein may be incorporated into (e.g., implemented within or performed by) a variety of apparatuses. In some aspects, a wireless apparatus implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music device, a video device, or a satellite radio), a global positioning system device, a camera, a wearable computing device (e.g., a smartwatch, a health or fitness tracker, etc.), an appliance, a sensor, a vending machine, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects, an apparatus (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless apparatus may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die.

The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; a, b and c; 2a, 2b; and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

The various features associated with the examples described herein and shown in the accompanying drawings can be implemented in different examples and implementations without departing from the scope of the present disclosure. Therefore, although certain specific constructions and arrangements have been described and shown in the accompanying drawings, such aspects are merely illustrative and not restrictive of the scope of the disclosure, since various other additions and modifications to, and deletions from, the described aspects will be apparent to one of ordinary skill in the art. Based on the teachings herein, one skilled in the art should appreciate that an aspect disclosed herein may be implemented independently of any other aspects and that two or more of these aspects may be combined in various ways.

Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims.

The above description is provided to enable any person skilled in the art to practice the various aspects described herein. Nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of communication, comprising:
receiving a first block;
determining whether the first block is associated with a fast associated control channel (FACCH);
conducting an integrity check on first FACCH information from the first block if the first block is associated with a FACCH;
determining whether a buffer contains second FACCH information, wherein the determination is made if the integrity check fails; and
combining the first FACCH information from the first block with the second FACCH information from the buffer if the buffer contains the second FACCH information.

2. The method of claim 1, further comprising:
storing received FACCH information in different buffers according to an cyclic pattern such that, for each of the cycles of the cyclic pattern, a corresponding one of the different buffers is used to store corresponding received FACCH information;
wherein, for each of the cycles of the cyclic pattern, the FACCH information from the corresponding buffer is combined with the first FACCH information.

3. The method of claim 2, wherein:
the different buffers consist of two buffers; and
the cyclic pattern comprises a ping-pong pattern.

4. The method of claim 1, further comprising:
determining whether a frame number associated with the first block is a potential repeated FACCH (R-FACCH) frame number; and
flushing the buffer if the frame number associated with the first block is a potential R-FACCH frame number and the first block is not associated with a FACCH.

5. The method of claim 4, further comprising:
flushing another buffer used for storing received FACCH information if the first block is associated with half-rate communication.

6. The method of claim 1, further comprising:
flushing the buffer if the integrity check passes.

7. The method of claim 1, wherein:
the first FACCH information comprises soft or hard decision information for the first block; and
the second FACCH information comprises soft or hard decision information for a second block that was received prior to the first block.

8. The method of claim 1, further comprising:
conducting a second integrity check on the combination of the first FACCH information with the second FACCH information; and
flushing the buffer if the combination passes the second integrity check.

9. The method of claim 1, further comprising:
conducting a second integrity check on the combination of the first FACCH information with the second FACCH information; and
storing the first FACCH information in the buffer if the combination fails the second integrity check.

10. The method of claim 1, further comprising:
receiving a second block;
determining that the second block corresponds to a potential repetition of the first block;
conducting a second integrity check on the second block; and
flushing the buffer if the second integrity check passes.

11. The method of claim 1, further comprising:
storing the first FACCH information in the buffer if the determination of whether the buffer contains second FACCH information indicates that the buffer is empty.

12. The method of claim 1, wherein the determination of whether the first block is associated with a FACCH comprises determining whether a variable indicates that a frame number associated with the first block is a potential repeated FACCH (R-FACCH) frame number.

13. The method of claim 12, wherein the frame number associated with the first block is a potential repeated FACCH (R-FACCH) frame number if the frame number associated with the first block is separated from a frame number of a prior FACCH frame by a defined offset.

14. The method of claim 13, wherein the offset is eight frames or nine frames.

15. The method of claim 14, wherein the offset is nine frames if the frame number associated with the first block and the frame number of the prior FACCH frame are separated by either a slow associated control channel (SACCH) frame or an idle frame.

16. An apparatus for communication, comprising:
a memory device;
a processing circuit coupled to the memory device and configured to:
receive a first block;
determine whether the first block is associated with a fast associated control channel (FACCH);
conduct an integrity check on first FACCH information from the first block if the first block is associated with a FACCH;
determine whether a buffer contains second FACCH information, wherein the determination is made if the integrity check fails; and
combine the first FACCH information from the first block with the second FACCH information from the buffer if the buffer contains the second FACCH information.

17. The apparatus of claim 1, wherein:
the processing circuit is further configured to store received FACCH information in different buffers according to an cyclic pattern such that, for each of the cycles of the cyclic pattern, a corresponding one of the different buffers is used to store corresponding received FACCH information; and
for each of the cycles of the cyclic pattern, the FACCH information from the corresponding buffer is combined with the first FACCH information.

18. The apparatus of claim 2, wherein:
the different buffers consist of two buffers; and
the cyclic pattern comprises a ping-pong pattern.

19. The apparatus of claim 1, wherein the processing circuit is further configured to:
determine whether a frame number associated with the first block is a potential repeated FACCH (R-FACCH) frame number; and
flush the buffer if the frame number associated with the first block is a potential R-FACCH frame number and the first block is not associated with a FACCH.

20. The apparatus of claim 4, wherein the processing circuit is further configured to:
flush another buffer used for storing received FACCH information if the first block is associated with half-rate communication.

21. The apparatus of claim 1, wherein the processing circuit is further configured to:
flush the buffer if the integrity check passes.

22. The apparatus of claim 1, wherein:
the first FACCH information comprises soft or hard decision information for the first block; and
the second FACCH information comprises soft or hard decision information for a second block that was received prior to the first block.

23. The apparatus of claim 1, wherein the processing circuit is further configured to:
determine whether the combination of the first FACCH information with the second FACCH information passes a second integrity check; and
flush the buffer if the combination passes the second integrity check.

24. The apparatus of claim 1, wherein the processing circuit is further configured to:
determine whether the combination of the first FACCH information with the second FACCH information passes a second integrity check; and
store the first FACCH information in the buffer if the combination fails the second integrity check.

25. The apparatus of claim 1, wherein the processing circuit is further configured to:
receive a second block;
determine that the second block corresponds to a potential repetition of the first block;
conduct a second integrity check on the second block; and
flush the buffer if the second integrity check passes.

26. The apparatus of claim 1, wherein the processing circuit is further configured to:
store the first FACCH information in the buffer if the determination of whether the buffer contains second FACCH information indicates that the buffer is empty.

27. The apparatus of claim 1, wherein the determination of whether the first block is associated with a FACCH comprises determining whether a variable indicates that a frame number associated with the first block is a potential repeated FACCH (R-FACCH) frame number.

28. The apparatus of claim 27, wherein the frame number associated with the first block is a potential repeated FACCH (R-FACCH) frame number if the frame number associated with the first block is separated from a frame number of a prior FACCH frame by a defined offset.

29. An apparatus for communication, comprising:
means for receiving a first block;
means for determining whether the first block is associated with a fast associated control channel (FACCH);
means for conducting an integrity check on first FACCH information from the first block if the first block is associated with a FACCH;
means for determining whether a buffer contains second FACCH information, wherein the determination is made if the integrity check fails; and
means for combining the first FACCH information from the first block with the second FACCH information from the buffer if the buffer contains the second FACCH information.

30. A non-transitory computer-readable medium storing computer-executable code, including code to:
receive a first block;
determine whether the first block is associated with a fast associated control channel (FACCH);
conduct an integrity check on first FACCH information from the first block if the first block is associated with a FACCH;
determine whether a buffer contains second FACCH information, wherein the determination is made if the integrity check fails; and
combine the first FACCH information from the first block with the second FACCH information from the buffer if the buffer contains the second FACCH information.
